(19) United States
(12) Patent Application Publication
(10) Pub. No.: US 2019/0322561 A1
(43) Pub. Date: Oct. 24, 2019

(54) METHOD OF PRODUCING FERTILIZER FROM WASTEWATER SLUDGE AND SYSTEM FOR CARRYING OUT THE METHOD

(71) Applicants: Natalya STRUNNIKOVA, Jerusalem (IL); Oleg KASSIEN, Mariehamn (FI); Arie BEKKER, River Vale, NJ (US)

(72) Inventors: Natalya STRUNNIKOVA, Jerusalem (IL); Oleg KASSIEN, Mariehamn (FI); Arie BEKKER, River Vale, NJ (US)

(21) Appl. No.: 15/823,864

(22) PCT Filed: Jul. 25, 2017
(86) PCT No.: PCT/IL17/50831

§ 371 Date: Nov. 28, 2017

(30) Foreign Application Priority Data
Dec. 27, 2016 (UA) U 2016 13397

(51) Int. Cl. C02F 11/00; C02F 11/147; C02F 11/18; C05F 7/00

(52) U.S. Cl. CPC C02F 11/004; C02F 11/147; C02F 2101/006; C05F 7/00; C02F 11/185

(57) ABSTRACT

A method is proposed for producing a fertilizer from wastewater sludge by disinfecting a wastewater sludge in a layered form by heating at a temperature in the range of 70° C. and 80° C. and aging the heated wastewater sludge for three to five days at a temperature ranging between 30° C. to 36° C. The aging is preceded by admixing the wastewater sludge with a biological initiator. Also proposed is a system for carrying out the method. The system consists of a disinfecting unit having a heater for heating the wastewater sludge fed to the heater in a layered form and an aging unit having an aging chamber for accommodating the wastewater sludge fed from the disinfecting unit. The aging unit is provided with an agitator for admixing a biological initiator to the wastewater sludge that fills the aging chamber.

### FIELD OF THE INVENTION

The present invention relates to methods and systems for utilizing water sludge and other organic waste materials and, more particularly, to a method and a system using compost material as a biological initiator at a step of aging the water sludge. The present invention is also directed to the utilization of sludge contaminated by heavy metals and radionuclides.

### BACKGROUND OF THE INVENTION

The routine method of utilizing wastewater sludge is composting, which is extremely time-consuming. Russian Patent RU 2494083 issued on Sep. 27, 2013 to Gennady Ganin, et al. and Russian Patent RU 2489414 issued on 8 Oct. 2013 to Svetlana Pravkina, et al. disclose neutralization of pathogenic organisms within the sludge by admixing wood waste, straw, peat or similar filling agents to the previously mentioned sludge. Decomposition of wood and other filling agents in the sludge mass results in generation of a great quantity of heat. The sludge mass is heated up to a temperature around 70° C., whereby the treated sludge is disinfected. The crucial disadvantage of the composting method is long duration (several months) of the process. In the countries with warm climate, this technology is applicable all-year round, while, in the countries with long-lasting cold weather this technology can be used in the summertime only. Seasonal prevalence of the composting technology brings about accumulation of wastes in the cold-weather periods. For utilization of the accumulated wastes, vast areas located distantly from populated places should be allocated.

In order to expedite the process of disinfection, the wastewater sludge is heated, treated by chemicals, and irradiated by different radiation sources. It should be emphasized that heat treatment is the most cost-effective and safe technology, because this kind of technology can be implemented by means of low-end equipment and there is no radiation hazard.

US Patent Application Publication No. 20120096911 issued on Apr. 26, 2012 (inventor: Ya. Abramov, et al.) discloses a method of utilizing wastewater sludge. The previously mentioned method comprises thermal disinfection and fermentation by means of a mixture of azotobacter and nitrobactet cultures.

The process is characterized by admixing highly dispersed sodium humate to the wastewater sludge, which immobilizes heavy metal ions in the form of insoluble compounds.

U.S. Pat. No. 4,519,831 issued on May 28, 1985 to W. Moore discloses a method of converting sewage sludge solids into dense controlled release and attrition-resistant fertilizer agglomerates. The method is carried out by forming a fertilizer premix from dry sewage sludge solids and uncondensed liquid ureaform. Acidic material, preferably phosphoric acid, is distributed throughout the premix to bring the pH to between 4 and 6, and the premix is heated for 5 to 60 minutes to 120° C. The heated premix is compressed between solid surfaces under pressure to form agglomerates.

In addition, known in the art is Russian Patent No. RU2588646 issued on 7 Oct. 2016 to Mark Bokman, et al. This patent discloses a method for producing organic fertilizer from wastewater sediments by thermophilically treating a sewage sludge and aging the finished product. During the thermophilic phase, the sewage sludge is pasteurized by forcibly heating it in a heating chamber for a certain time, adding a bioactive component, mixing the components, and leaving the resulting mass for ageing to obtain the finished product. A bioactive component is comprised of a previously prepared aged fertilizer, and during the aging, the fertilizer is preheated mainly with the heat of air previously used for pasteurization of the sludge.

The method of RU2588646 has a number of disadvantages. The thermophilic stage of the process is carried out at a temperature of 55-65° C., which is not sufficient to ensure complete disinfection of the product during the prescribed with regard to certain viruses, fungi, etc. Furthermore, such a temperature regime will require a very long time, which in turn will lead to increased cost of the product and energy consumption. Shortening of the pasteurization time will lead to incomplete pasteurization and bacterial contamination to a level above the standard requirements. The proposed method is not suitable for producing fertilizers from sediments contaminated with heavy metals, and the use of a drum-type heating chamber will not provide heating through the entire mass and thus will not result in complete pasteurization of the starting material.

Thus, there is a long-felt and unmet need for a method and a system providing a complex organic fertilizer produced from wastewater sludge by a rapid process. Another specific need in this field of technology is utilization of wastewater sludge contaminated by heavy metals and radionuclides.

### SUMMARY OF THE INVENTION

The present invention relates to a method and a system for utilizing municipal wastewater sludge and other organic waste materials by using compost material as a biological initiator at a step of aging the wastewater sludge. The invention is also directed to the utilization of a sludge contaminated with heavy metals and radionuclides.

The method of the invention of producing fertilizer from wastewater sludge (hereinafter referred to merely as “the method”) consists of disinfecting the wastewater sludge by heating and then aging the treated sludge, wherein the step of aging is preceded by a step of admixing the sludge with a biological initiator. The biological initiator may be comprised of a compost material, a produced fertilizer, and any combination of the above components. Disinfecting of the wastewater sludge is performed within a layer having thickness not exceeding 5 cm. The steps of disinfecting of the wastewater sludge is performed at a temperature preferably within the range between 70° C. and 80° C. and for a period ranging between 25 min to 35 min. Aging of the wastewater sludge is performed at a temperature preferably in the range of 30° C. to 36° C. for a period ranging approximately between 3 days and 5 days. In the step of aging, the water content in the wastewater sludge is in the range of about 30% to 70%. The biological initiator is admixed to the wastewater sludge in ratio of 1:2.

A system for carrying out the method consists of a disinfecting unit that contains a heater configured for heating a wastewater sludge fed into the heater, and an aging unit that includes an aging chamber for accommodating the wastewater sludge fed from the disinfecting unit. The aging unit further contains a mechanism for admixing a biological initiator to the wastewater sludge accommodated within the aging chamber. The disinfecting unit is made in the form of a conveyor furnace. The system is also provided with a unit for admixing a sorbent material to the wastewater sludge for immobilization of heavy metals and radionuclides that may contain in the wastewater sludge. The sorbent may be comprised of a bentonite clay, which is admixed to the wastewater sludge in ratio ranging between 1:5 to 1:10 on a dry basis.

### BRIEF DESCRIPTION OF THE DRAWINGS

FIG. 1 is a flowchart of a method of the invention for producing a fertilizer from wastewater sludge.

FIG. 2 is a schematic presentation of a system for producing a fertilizer from wastewater sludge by the method of the invention.

FIG. 3 is a perspective view of an input loader used in the system of FIG. 2.

FIG. 4 is a perspective view of a conveyor of a furnace used in the system of FIG. 2.

FIG. 5 illustrates dumping disinfected wastewater sludge from the furnace.

FIG. 6 is a perspective view of an aging chamber used in the system of FIG. 2.

FIG. 7 illustrates successively loading a number of aging chambers.

FIG. 8 is an internal perspective view of an exemplary embodiment of an aging chamber.

FIG. 9 is an external perspective view of an exemplary embodiment of an aging chamber.

### DETAILED DESCRIPTION OF THE INVENTION

The present invention relates to a method and system for utilizing municipal wastewater sludge and other organic waste materials and, more particularly, to a method and a system using compost material as a biological initiator at a step of aging the wastewater sludge. The present invention is also directed to the utilization of sludge contaminated with heavy metals and radionuclides.

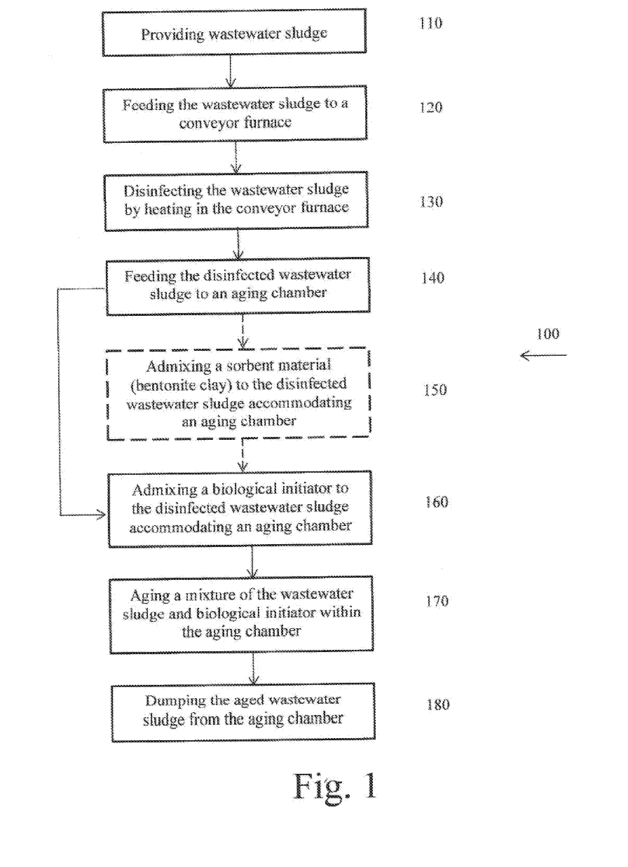

Reference is now made to FIG. 1, which presents a flowchart of a method 100 implementing production of fertilizer from wastewater sludge. It should be understood that, in terms of the present application, all kinds of organic wastes such as animal wastes, municipal wastes and similar are in the scope of the present invention. At the start of the method, the wastewater sludge is provided (step 110). The provided sludge is fed into a conveyor furnace (step 120) where the sludge is exposed to disinfection by means of heat treatment (step 130). A sludge layer with thickness of no more than 5 cm is processed for a time ranging between 25 min to 35 min. The heat treatment of the sludge should be conducted at a temperature within the sludge layer in the range of 55 to 100° C. If the sludge disinfection temperature is below 55° C., viruses are not destroyed and viable eggs of helminths are preserved. However, a preferable temperature range for thermal treatment of the sludge is between 70° C. and 80° C. Next, the disinfected sludge is fed into an aging chamber (step 140).

There are two aspects of the present invention:

According to one aspect, the disinfected sludge is mixed with a biological initiator (step 160), which can be a compost material, a fertilizer previously produced according to the current invention fertilizer, or their mixture. The mixture ratio between the sludge to be processed and the biological initiator is about 2:1. Step 170 of aging the sludge lasts for a time of about 3 days to 5 days. Agitation of the sludge mass accommodated in the aging chamber is in the scope of the present invention. Dumping or outputting of the produced fertilizer onto a conveyor is implemented at step 180.

According to the second aspect of the present invention, which is specifically applicable to a wastewater sludge contaminated with heavy metals and radionuclides, at step 150, a sorbent material is admixed to the sludge. The function of the sorbent material (for example, bentonite clay) is to immobilize ions of the abovementioned contaminants and prevent cultivated plants from further contamination.

It is a core purpose of the method of the invention is to age the wastewater sludge preceded by admixing a biological initiator, wherein the biological initiator is selected from a compost material, a produced fertilizer, and any combination of both. As mentioned above, the wastewater sludge is disinfected in a layer having a thickness not exceeding 5 cm and at a temperature, preferably in the range of 55° C. to 100° C., preferably at 70° C. to 80° C. At that preferable temperature, the disinfecting is carried out for a time ranging between about 25 min to 35 min. The step of aging of the wastewater sludge is performed at temperature ranging between about 30° C. to 42° C. At temperatures below 30° C. degrees, the processes of vital activity of microorganisms participating in the fertilization process are critically delayed. On the other hand, if the temperature of the mixture at the aging stage exceeds 42° C., the microorganisms present in the fertilizers involved in the maturation process will perish.

According to the method of the invention, the content of water in the wastewater sludge at the step of aging should be in the range of about 30% to 70%. The biological initiator is admixed to the wastewater sludge in a ratio of 1:2. Admixing a sorbent material to the wastewater sludge makes it possible to immobilize heavy metals and radionuclides that may be contained in the sludge. A sorbent may be comprised of a bentonite clay. The sorbent is admixed to the wastewater sludge in ratio ranging from 1:5 to 1:10 on a dry basis.

In treating a wastewater sludge of high humidity (e.g., above 70%), it is possible to introduce into the initial wet sludge an old sewage sludge (humidity 20% or less). This will reduce the energy costs of evaporation of water to obtain a fertilizer of a specified humidity (50-60%). Humidity in a mixture of fresh sewage sludge (of different humidity) with an old sewage sludge (per 100 g of the fresh sewage sludge) is shown in Tables 1 and 2.

TABLE 1
Humidity in a Mixture of Fresh Sludge (humidity of 80%) with
an Old Sewage Sludge (per 100 g of the fresh sewage sludge)

| Percent of | Mass of | | Percent of | Mass of | |
|---|---|---|---|---|---|
| addition of | added | Humidity | addition of | added | Humidity |
| old sludge | dry sub- | of | old sludge | dry sub- | of |
| having 10% | stance, | mixture, | having 20% | stance, | mixture, |
| humidity | g | % | humidity | g | % |
| 10 | 9 | 73.6 | 10% | 8 | 74.5 |
| 20 | 18 | 69.7 | 20% | 16 | 70.0 |
| 30 | 27 | 65.7 | 30% | 24 | 66.2 |

TABLE 2
Humidity in a Mixture of Fresh Sludge (humidity of 75%) with
an Old Sewage Sludge (per 100 g of the fresh sewage sludge)

| Percent of | Mass of | | Percent of | | |
|---|---|---|---|---|---|
| addition of | added | Humidity | addition of | Mass of | Humidity |
| old sludge | dry sub- | of | old sludge | added | of |
| having 10% | stance, | mixture, | having 20% | dry sub- | mixture, |
| humidity | g | % | humidity | stance, g | % |
| 10 | 9 | 65.1 | 10 | 8 | 70 |
| 20 | 18 | 64.2 | 20 | 16 | 65.9 |
| 30 | 27 | 60 | 30 | 24 | 62.3 |

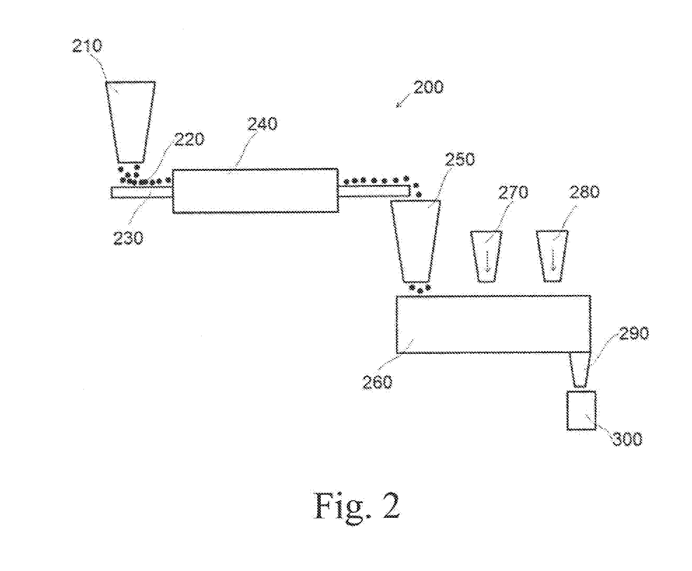

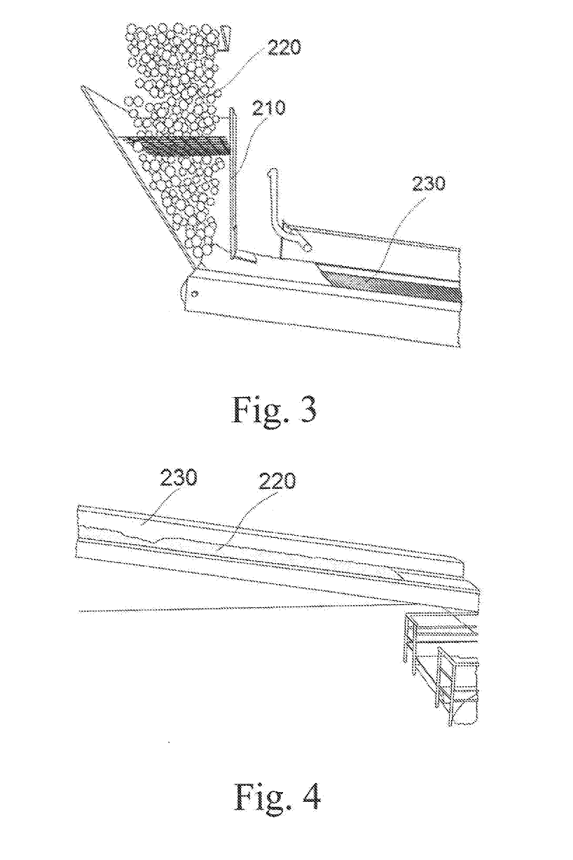

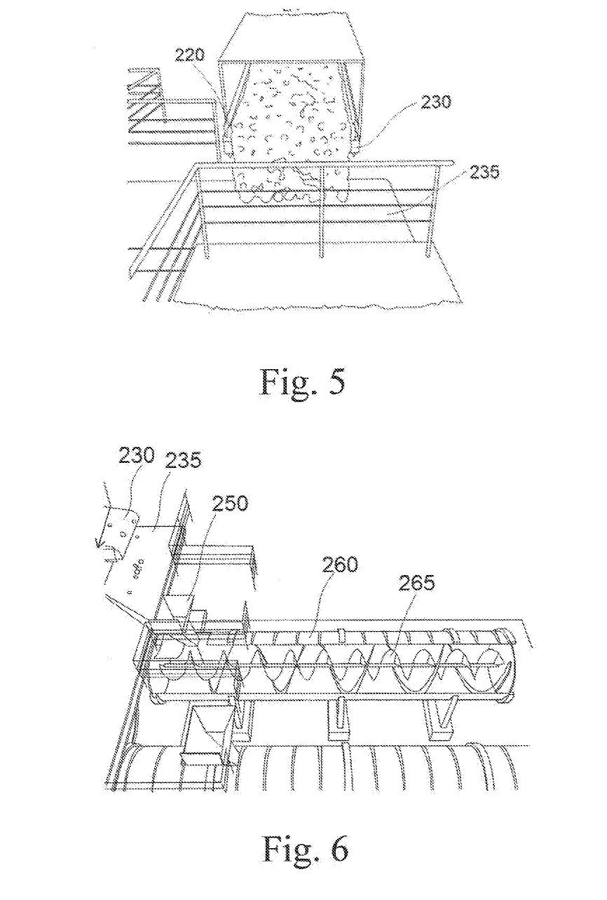

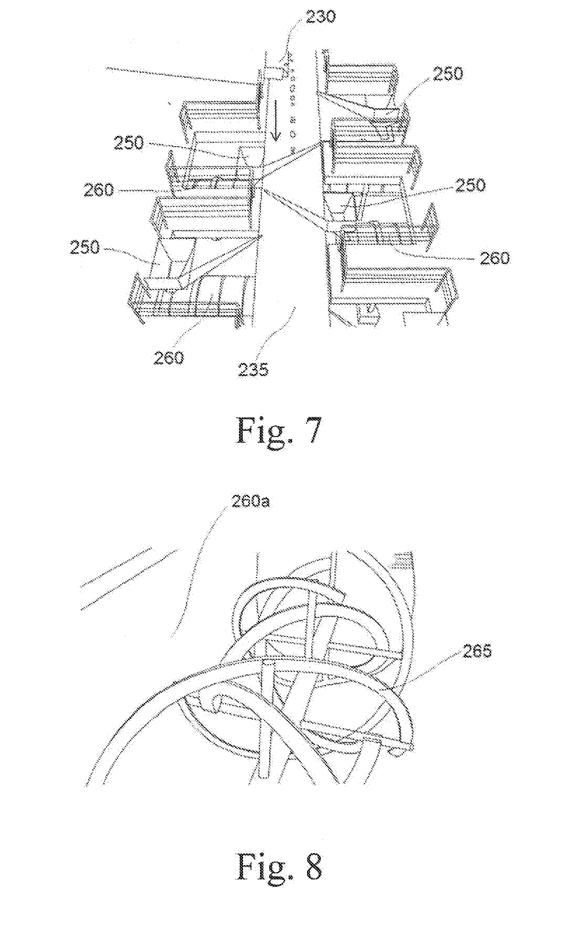

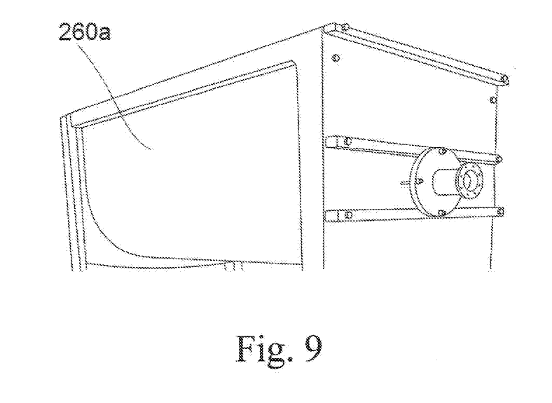

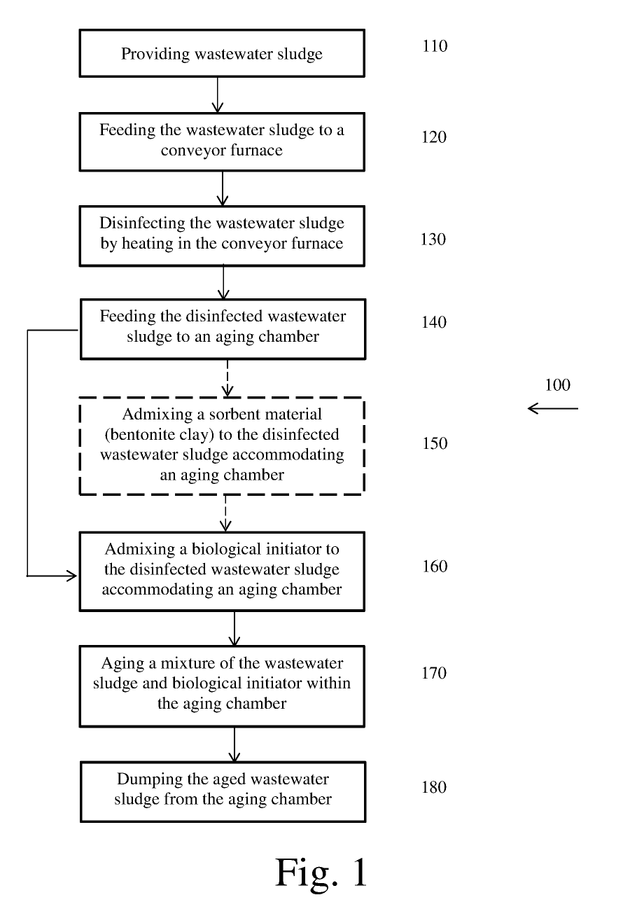

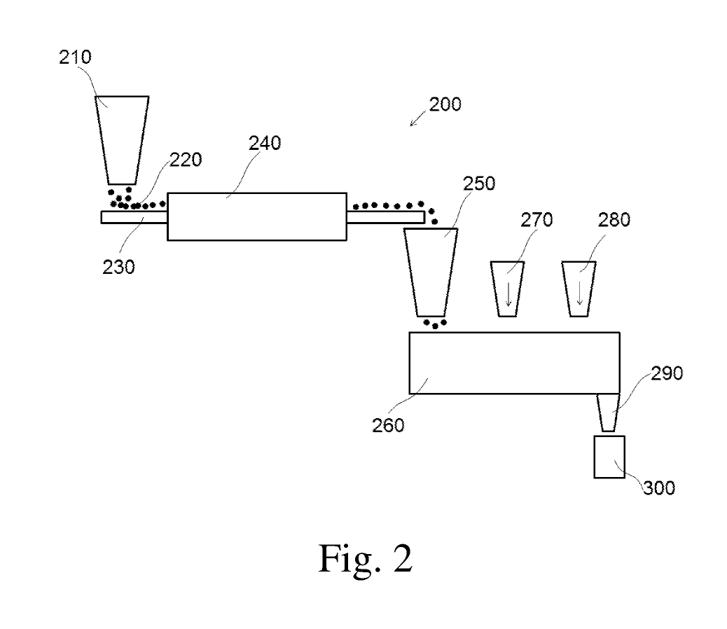

Reference is now made to FIG. 2, presenting a schematic view of a system 200 for producing a fertilizer from wastewater sludge. A wastewater sludge 220 is fed by a first loader 210 onto a transportation belt 230. The sludge 220 travels via a furnace 240 and is exposed to heat. The previously mentioned heat treatment results in disinfection of the sludge 220. Next, the disinfected sludge is fed by a second loader 250 to an aging chamber 260. Reference numerals 270 and 280 refer to loaders, which feed a biological initiator and a sorbent material, respectively. As described above, the biological initiator and the sorbent material are admixed to the disinfected sludge accommodated in the aging chamber 260, which is provided with an internal agitator (not shown). The aged sludge (produced fertilizer) is dumped from the aging chamber 260 via a discharger 290 to a packing machine 300.

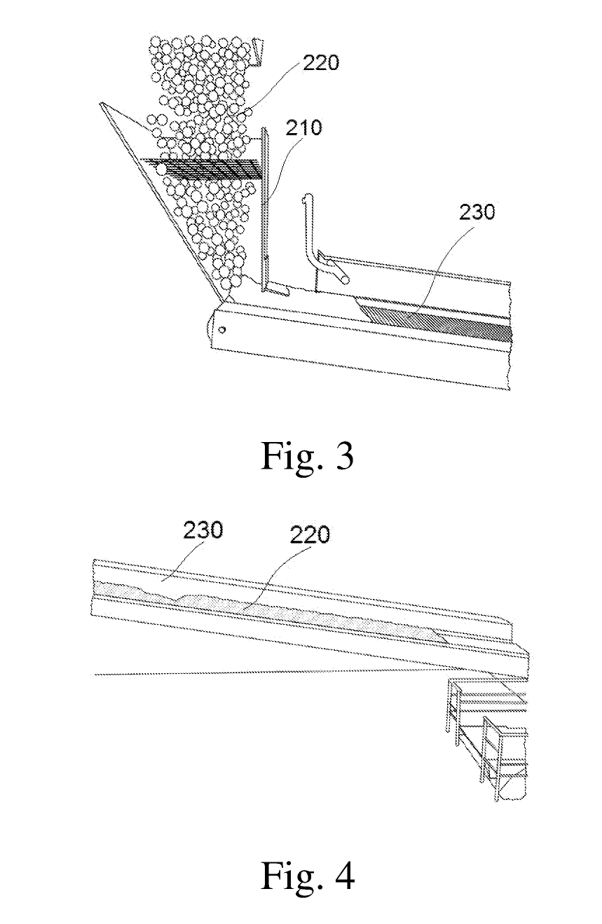

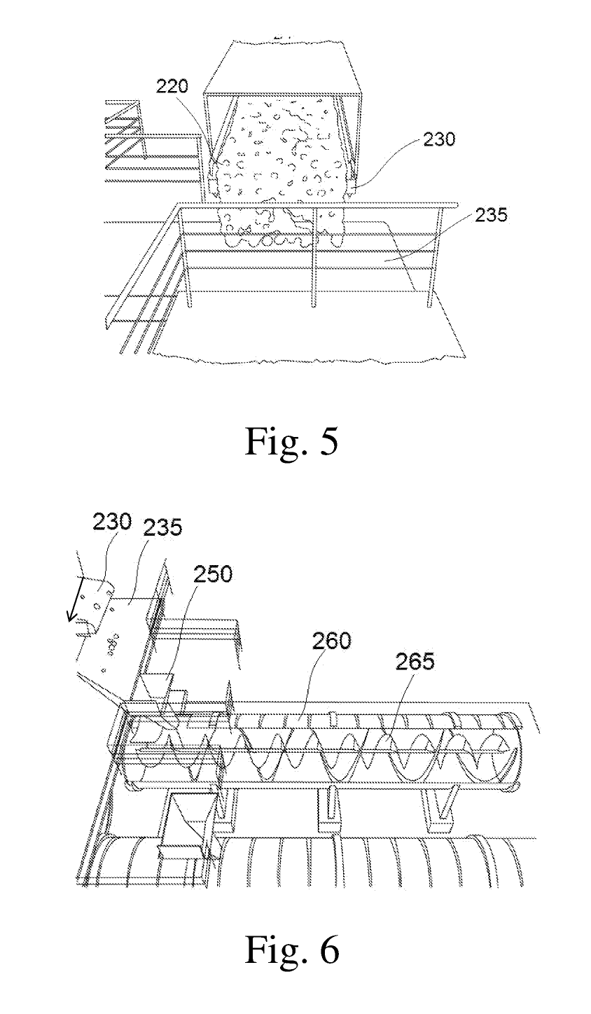

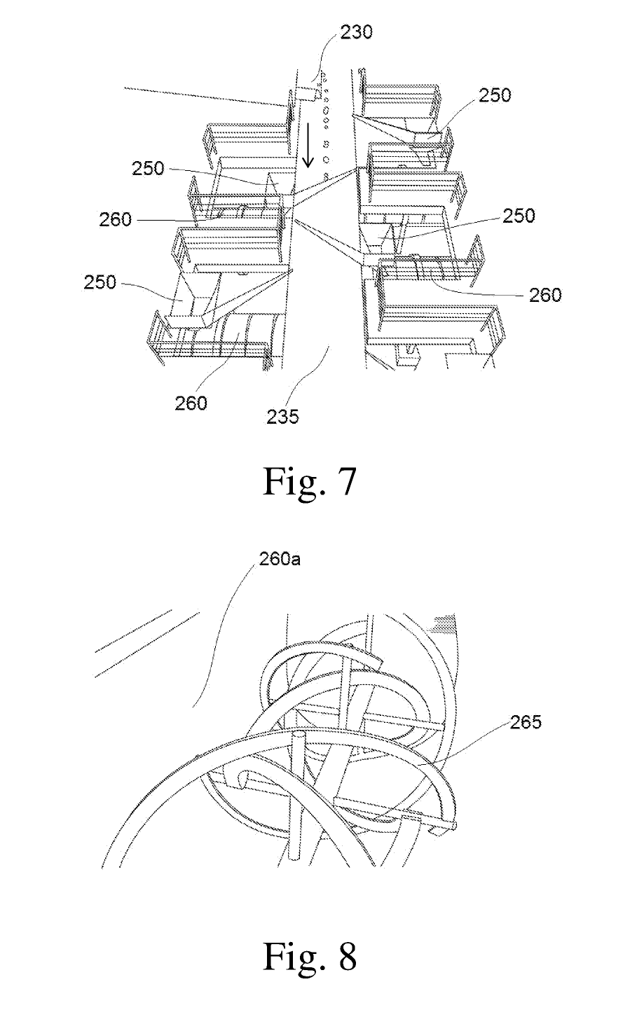

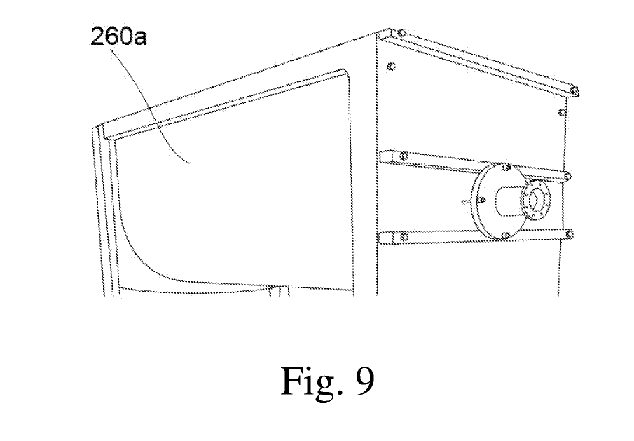

Reference is now made to FIGS. 3 to 9, illustrating the operation of the system 200. Specifically, FIG. 3 is a perspective view where sludge 220 is fed by the loader 210 to the conveyor 230. FIG. 4 provides a general view of a transportation belt 230 carrying the sludge 220. In FIG. 5, the disinfected sludge 220 is transferred from the transportation belt 230 to a transportation belt 235. FIG. 6 illustrates feeding the disinfected sludge 220 into the aging chambers 260. As mentioned above, the disinfected sludge 220 is transferred from the transportation belt 230 to the transportation belt 235 and, then, via the loader 250 is fed into the aging chamber 260. The previously mentioned aging chamber is provided with an agitator 265 configured for stirring the sludge and admixing a biological initiator and a sorbent material to the sludge. FIG. 7 shows an arrangement of a plurality of the aging chambers 260, which are successively loadable by means of the loaders 250, which are movable up to the transportation belt 235. FIGS. 8 and 9 present internal and external views of an exemplary embodiment of an aging chamber 260a made in a shape of a trough pan. The aging chamber 260a is also provided with an agitator 265. A piped aging chamber 260 can be provided with a discharge end shield. When the discharge end shield is open, the produced fertilizer is conveyed by the transportation belt to a packing machine (not shown).

### Example 1

A 5-cm layer of a wastewater sludge dehydrated by centrifuge treatment up to humidity of 80% was placed into a metal basket. Then, the wastewater sludge was disinfected by heat treatment for 30-minute at a temperature of 70° C. to 80° C. within the sludge layer. After the disinfection step, the sludge of 75% humidity was mixed with a previously produced compost material (fertilizer) of 25% to 30% humidity in a ratio of 2:1. The obtained mixture (2 parts of the disinfected sludge and 1 part of the previously produced compost material or fertilizer) had humidity of 40% to 45%. The previously mentioned mixture was aged in an aging chamber for 4 days to 5 days at a temperature of 30° C. to 36° C. After the step of aging, the produced fertilizer was free of unpleasant odor. The produced fertilizer was characterized by the following:

| | |
|---|---|
| Nitrogen total | 3.5 wt. % to 4.0 wt. % |
| Phosphorus expressed as P₂O₅ | 1.0 wt. % to 1.1 wt. % |
| Potassium expressed as K₂O | 1.5 wt. % to 1.8 wt. % |

Bacterial count (coliform index) complies with standards and regulations for fertilizers.

### Example 2

A mixture of a wastewater sludge with a biological floc of 95% to 98% humidity was dehydrated and exposed to heat treatment in a furnace. The 5-cm layer of the sludge/floc mixture was heated in the furnace for 30 min at a temperature of 150° C. to 200° C. such that the temperature within the sludge/floc mixture layer was 70° C. to 80° C. The heated sludge/floc mixture was mixed with a sorbent material (bentonite clay) in a ratio from 1 part to 2 parts of the bentonite clay to 10 parts of the abovementioned mixture. After obtaining a homogeneous mixture, a previously produced compost material (fertilizer) was added in a ratio of 1:2. The resulting product was aged in the aging chamber for 5 days at a temperature of 30° C. to 36° C.

Comparison of concentrations of heavy metals and their mobile forms in the initial sludge/floc mixture and the obtained fertilizer as exemplified by lead and copper was carried out. According to the obtained results, while total concentrations of heavy metals in the produced fertilizer corresponded to the concentrations in the initial sludge/floc mixture, mobile forms demonstrated decrease in concentrations. Specifically, the concentration of lead mobile forms was 2 to 2.5 times less than that in the initial sludge/floc mixture. Similarly, the copper mobile form concentrations decreased 2.5 to 3 times.

Experimental plants grown with fertilizer produced according to the present invention showed increase in plant mass by 20% to 30% compared with a control experiment where the fertilizer was not applied. The experimental plants were taller than control plants by about 1.4 to 1.5 fold.

The invention was described with reference to specific examples and illustrated with specific drawings. However, any changes and modifications are possible without deviation from the scope of the attached patent claims. For example, the temperature regimes may be changed in both directions whereby the aging periods may also vary. The aging process can be accompanied by forceful supply of oxygen. Units of equipment also may be different provided they accomplished their functions. A commercial bacterial activator can be used instead of a compost material or fertilizer.

1. A method of producing fertilizer from wastewater sludge; said method comprising steps of:
a. disinfecting said wastewater sludge by heating thereof;
b. aging said wastewater sludge;
wherein said step of aging said wastewater sludge is preceded by a step of admixing a biological initiator.

2. The method according to claim 1, wherein said biological initiator is selected from the group consisting of a compost material, a produced fertilizer and any combination thereof.

3. The method according to claim 1, wherein said step of disinfecting said wastewater sludge is performed within a layer having thickness ranging between 3 cm to 5 cm.

4. The method according to claim 3, wherein said step of disinfecting said wastewater sludge is performed at temperature within said layer ranging between 70° C. and 80° C.

5. The method according to claim 1, wherein said step of disinfecting said wastewater sludge is performed for a time period ranging between 25 min to 35 min.

6. The method according to claim 1, wherein said step of aging said wastewater sludge is performed at temperature ranging between 30° C. to 36° C.

7. The method according to claim 1, wherein said step of aging said wastewater sludge is performed for a time period ranging between 3 days and 5 days.

8. The method according to claim 1, wherein water content in said wastewater sludge at said step of aging is between 30% to 50%.

9. The method according to claim 1, wherein said biological initiator is admixed in ratio 1:2 in relation to said wastewater sludge.

10. The method according to claim 1 comprising a step of admixing a sorbent material to said wastewater sludge for immobilizing heavy metals and radionuclides contained therewithin.

11. The method according to claim 9, wherein said sorbent is bentonite clay.

12. The method according to claim 10, wherein said sorbent is admixed to said wastewater sludge in ratio ranging between 1:5 to 1:10 on dry basis.

13. A system for producing a fertilizer from a wastewater sludge; said system comprising:
a. a disinfecting unit comprising a heater configured for heating said wastewater sludge fed thereinto;
b. an aging unit comprising an aging chamber accommodating said wastewater sludge fed from said disinfecting unit;
wherein said aging unit further comprises means for admixing a biological initiator to said wastewater sludge accommodated within said aging chamber.

14. The system according to claim 13, wherein said biological initiator is selected from the group consisting of a compost material, a produced fertilizer and any combination thereof.

15. The system according to claim 13, wherein said disinfecting unit comprises a conveyor furnace.

16. The system according to claim 13, wherein disinfection of said wastewater sludge is performed within a layer having thickness ranging between 3 cm to 5 cm carried by a belt of said conveyor furnace.

17. The system according to claim 16, wherein said disinfection of said wastewater sludge is performed at temperature within said layer ranging between 70° C. and 80° C.

18. The system according to claim 13, wherein said disinfection of said wastewater sludge is performed for a time period ranging between 25 min to 35 min.

19. The system according to claim 13, wherein temperature of said wastewater sludge accommodated within said aging chamber ranges between 30° C. to 36° C.

20. The system according to claim 13, wherein aging of said wastewater sludge is performed for a time period ranging between 3 days and 5 days.

21. The system according to claim 13, wherein water content in said wastewater sludge at said step of aging is between 30% to 50%.

22. The system according to claim 13, wherein said biological initiator is admixed in ratio 1:2 in relation to said wastewater sludge.

23. The system according to claim 13 comprising means for admixing a sorbent material to said wastewater sludge for immobilization of heavy metals and radionuclides contained therewithin.

24. The system according to claim 23, wherein said sorbent material is bentonite clay.

25. The system according to claim 24, wherein said sorbent is admixed to said wastewater sludge in ratio ranging between 1:5 to 1:10 on dry basis.
